(19) United States
(12) Patent Application Publication
(10) Pub. No.: US 2008/0253933 A1
(43) Pub. Date: Oct. 16, 2008

(54) Liquid Photometry

(76) Inventor: Jonathan Redfern, Cambridge (GB)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 12/093,579

(22) PCT Filed: Nov. 15, 2006
(86) PCT No.: PCT/GB2006/004249

§ 371 Date: May 13, 2008

(30) Foreign Application Priority Data
Nov. 15, 2005 (GB) 0523231.9

(51) Int. Cl. B01L 3/02

(52) U.S. Cl. 422/100

(57) ABSTRACT

A photometric or spectrophotometric apparatus and method wherein a sample is contained in a pipette held between two surfaces, one containing a photometric or spectrophotometric source and the other a photometric or spectrophotometric detector and an optical path is established through the walls of the pipette tip and through the sample between the two surfaces. Use of a disposable pipette tip which may be left attached to pipette tip during sample analysis or reattached to the pipette device following analyses, provides a means to recover the sample for subsequent applications and manipulations, and enables especially small volume samples to be analysed.

### BACKGROUND OF THE INVENTION

The invention relates to the field of photometry, spectrophotometry, fluorometry, spectrofluorometry and the like and their use in optically quantitating and or characterizing liquids and solutions.

More particularly the invention relates to ultra low volume instruments working in the volume range of microtitres and picolitres. Such devices are particularly useful in quantitation of biotechnology samples including nucleic acids or proteins where it is desirable to keep sample loss and/or cross-contamination to a minimum.

Liquids, mixtures, solutions and reacting mixtures are often characterized using optical techniques such as photometry, spectrophotometry, fluorometry, or spectrofluorometry. In order to characterize samples of these liquids, the liquid is usually contained in a vessel referred to as a cell or cuvette two or more of whose sides are of optical quality and permit the passage of those wavelengths needed to characterize the liquid contained therein. In the case of photometry or spectrophotometry, the value most commonly sought is the sample absorbance A defined by

A=−log T

Where T is the transmittance, or

A=log(l/l·sub·0)

where l.sub.0 is the level of light transmitted through a blank sample (one containing all components except the one being measured or one whose absorbance is known to be negligible and with optical properties identical to those of the sample being measured), and l the level of light transmitted through the sample being measured. Most commonly the absorbance value is measured in a cell or cuvette with a 1 cm path length.

Lambert's Law states that for a collimated (all rays approximately parallel) beam of light passing through a homogeneous solution of uniform concentration the absorbance is proportional to the path length through the solution. For two path lengths X and Y,

(Absorbance x)/(Absorbance y)=(Path length x)/(Path length y)

It is reasonable that absorbance can be measured with path lengths other than 1 cm and corrected for path length to the equivalent value for a 1 cm path which can be more easily compared to data from other spectrophotometers. But establishing a collimated optical light path of known length through liquids confined by a container such as a quartz cuvette these have proven inadequate for microlitre volumes <10 ul liquids has been perceived as difficult and expensive.

When dealing with very small sample volumes of say from 1 to 10 microlitres, it is difficult to create cells or cuvettes small enough to be filled and permit the industry standard 1 cm optical path to be used. It is also difficult and/or time consuming to clean these cells or cuvettes for use with another sample.

### STATE OF THE ART

The recent advent of small spectrometers designed to be used with fibre optics has made it possible to consider spectrophotometric geometries not readily possible before.

The prior art to WO 01/14855 A1 contains examples of attempts to supply low volume instruments. World Precision Instruments of Sarasota, Fla. offers parts from which an instrument handling less than 20 microlitres can be built for around $3000. This uses a fibre optic dipping probe with a tip diameter of 1.5 mm (Dip Tip®), their miniature fibre optic spectrometer and F-O-Lite H light source. With a deuterium lights source (D2Lux) a UV spectrophotometer can be constructed.

U.S. Pat. No. 4,643,580 to Gross et al. discloses a photometer head in which there is a housing for receiving and supporting small test volumes. A fibre optic transmitter and receiver are spaced within the housing so that a drop can be suspended between the two ends.

McMillan, in U.S. Pat. No. 4,910,402, discloses apparatus in which a syringe drops liquid into the gap between two fixed fibres and an IR pulse from a LED laser is fed through the droplet. The output signal is analysed as a function of the interaction of the radiation with the liquid of the drop.

Ocean Optics, of Dunedin, Fla. 34698 supplies a SpectroPipetter for microlitre-volume samples using a sample volume of about 2 microlitres. The optics carry light down through the plunger to and from the sample. The tip of the pipette includes a proprietary micro-sample cell that acts as an optical waveguide for aqueous sample solutions.

The total relevant art known to the applicant is as follows:

### U.S. Patent Documents

| | | |
|---|---|---|
| 4286881 | September, 1981 | Janzen |
| 4643580 | February, 1987 | Gross et al. |
| 4910402 | March, 1990 | McMillan. |
| 5739432 | April, 1998 | Sinha. |
| 5926262 | July, 1999 | Jung et al. |
| 6628382 | September, 2003 | Robertson. |
| 68098326 | October, 2004 | Robertson. |

### WO Patent Documents

| | | |
|---|---|---|
| WO 01/14855 | March, 2001 | Robertson |

### Other References

World Precision Instruments Laboratory Equipment Catalogue Sarasota, Fla., US pp. 114-115 117-118.
Ocean Optics Cuvette Holders for 1-cm Cuvettes Dunedin, Fla., US pp. 1-4.

Each of these gives guidance as to the overcoming of the problem of dealing with very small sample volumes, but none of them really addresses the practical needs of the worker in the field, i.e. how to overcome the drawbacks of known pipette and cuvette usage as outlined above. Solutions of the Robertson type are all very well but they do not address these practical problems. They result only in the construction of relatively static unadaptable working apparatus on principles which are now well established; whereas what the researcher really needs is not a restatement of such principles but a novel, simple, immediately usable way of optimising—in practical usage situations—the microsampling techniques which they make possible.

### THE INVENTIVE CONCEPT

To this end the invention uses a pipette tip as a containment vessel for microtitre or submicrolitre volume liquid samples. The pipette tip provides a convenient means to confine the sample within the analysis region of an optical analysis instrument and to carry out the requisite measurement across a fixed and know distance (the path length). The pipette tip removes the requirement to transfer the sample to another container for measurement such as a quartz cuvette thereby simplifying the procedure and reducing risk of sample and user contamination. Use of a pipette tip provides a convenient vessel allowing for recovery of the sample for further downstream processing. The pipette tip reduces the speed of sample evaporation by reducing the samples exposure to the air.

### SCOPE OF THE INVENTION

The scope of the invention is defined in the claims and as originally filed these are:
1. A pipette tip which is optically adapted for photometric or spectrophotometric analysis of a relatively small volume—for example, from 1 to 10 microlitres—of liquid contained therein and which is adapted to be readily attachable to and detachable from a pipette barrel in use.
2. A pipette tip according to Claim 1 and characterised by the feature that an external portion of the pipette tip is ribbed in order to assist its attachment to and detachment from the pipette barrel.
3. A pipette tip according to Claim 2 and characterised by the feature that there is more than one rib and that some at least of said ribs extend axially along the surface of the ribbed region.
4. A pipette tip according to any preceding claim and in which the end region of the pipette tip remote from that opposite end region which, in use, fits onto the pipette barrel, has a uniform wall thickness in the order of 0.25 mm.
5. A pipette tip according to Claim 4 and in which the said end region of approximately uniform wall thickness occupies approximately one third to one half of the overall length of the pipette tip.

6. A pipette tip according to Claim 5 and in which approximately the last three fifths of the region of uniform wall thickness is of uniform internal and/or external diameter.
7. Apparatus comprising a pipette tip according to any preceding claim in combination with a pipette adapted to co-operate therewith for use in photometric or spectrophotometric analysis.
8. Apparatus according to Claim 7 and comprising means to hold the pipette tip and its sample in an optical path for delivery and measurement of radiation passed across the tip and hence through the sample; and means permitting the tip to be attached to and removed from the apparatus to allow differing samples to be substituted and analysed.
9. Apparatus according to the preceding claim and in which the necessary radiation source means and receiving means are formed into one substantially continuous surface surrounding the pipette tip sample containing region in use.
10. Methods of photometric, spectrophotometric, fluorometric or spectrofluorometric analysis of liquids contained in apparatus according to any of the preceding claims and using a pipette tip in accordance with Claim 1.

### EMBODIMENTS OF INVENTION

The invention is embodied in an optical instrument for photometric, spectrophotometric, fluorometric or spectroftuorometric analysis of liquids contained in a disposable pipette tip held between two substantially parallel surfaces spaced apart a known distance (the pipette tip holder), wherein the sample liquid is confined by the pipette tip. At least two optical fibres penetrate the parallel surfaces. One fibre is the source and the other the receiver. Ordinarily each of the surfaces contains an optical fibre. These fibres are mounted coaxially with and perpendicular to the parallel confining surfaces. The shape of the surfaces serve to confine the pipette tip so as to centre the confined pipette tip in the optical path of the optical fibres imbedded in the surfaces. The surfaces may be formed in to one cylindrical surface surrounding the pipette tip. Following detection the pipette tip may be removed from the pipette tip holder.

For some applications, the optical fibres can be replaced by miniature sources like light emitting diodes (LEDs) and detectors or detectors with optical filters. The LEDs with their characteristically small emitting area would replace the source fibre and small solid state detectors with associated filters like those used in colour charge coupled devices (CCDs) for imaging would replace the receiving fibre and spectrometer.

### DESCRIPTION OF PRESENTLY PREFERRED EMBODIMENTS

In the accompanying drawings:

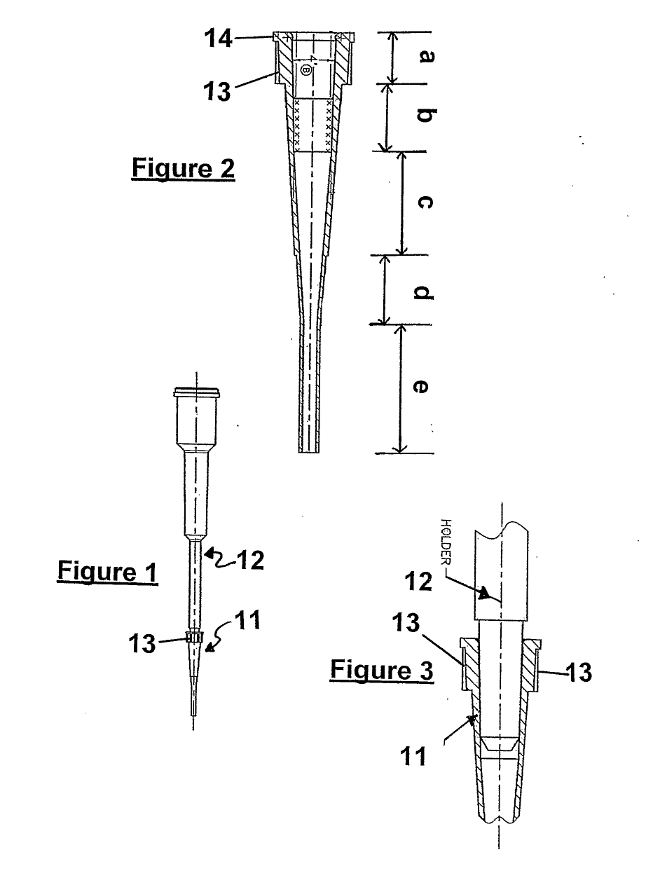

FIGS. 1, 2 and 3 show the construction and in the use-deployment of a pipette tip embodying one aspect of the invention, with FIG. 1 being drawn to a smaller scale than that of FIGS. 2 and 3, each of which is drawn to the same overall scale;

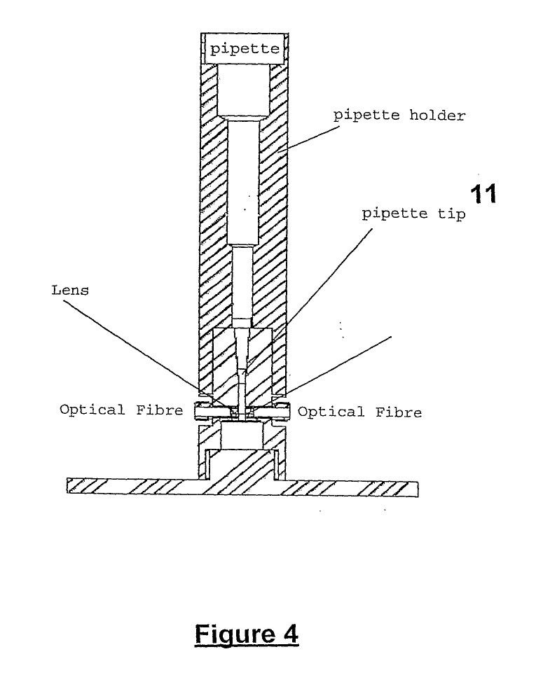

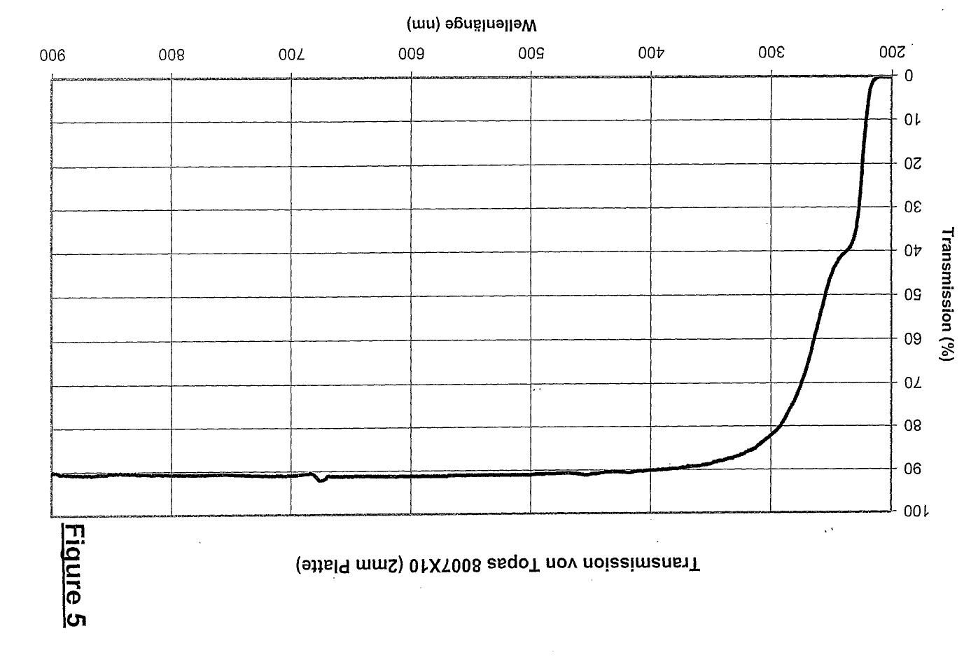

FIG. 4 shows the pipette tip in use as part of a liquid spectrophotometric analysis apparatus;

FIG. 5 is a graph showing the optical transmissibility of a pipette tip made with a presently preferred specific material by way of example only.

### INTRODUCTION TO THE PREFERRED EMBODIMENTS

Current spectroscopic protocols require that the sample is i) aspirated from containment tube ii) dispensed into cuvette vessel iii) aspirated out of cuvette iv) dispensed back into containment tube.

The invention postulates the use of a disposable pipette tip together with a standard pipette as a method to aspirate (suck-up) liquid for subsequent detection within the same pipette tip and subsequently allowing complete recovery of the said sample through standard pipette dispensing procedure. I.E. the use of a disposable pipette tip as the containment vessel for reaction and/or detection of changes in spectroscopic properties within the sample.

The pipette tip is a novel platform that enables the user to aspirate, analyse and dispense a given sample without transfer to an intermediary reaction vessel.

The liquid sample is contained in a pipette tip, which is held between two surfaces. Transmitted radiation typically but not limited to the UV region, is emitted from the system through an optical fibre and subsequently through the wall of the pipette tip and across the liquid sample and is collected by a second fibre or light pipe and sent on to the analysis photometer or spectrometer

Measurements of the level of fluorescence of samples can be made by adding an excitation filter to the light source (not shown) and an emission filter to the detector (also not shown) to specifically reject all light from the excitation source at the detector. The level of fluorescence will, thus, be directly dependent on the length of the optical path between the fibre optics. The excitation can also be brought to the sample through fibres surrounding the collection fibre. This reduces the need for a high level of excitation wavelength rejection on the part of the spectrometer or other detector collecting the light from the sample through collection.

Samples are loaded into the pipette tip with a pipetting means such as a 10 or 25 microlitre Gilson Microman pipette. When sufficient volume is introduced into the pipette tip a column of liquid will form which will have a diameter equal to the internal diameter of the pipette tip. This distance is constant and defines the path length. The fibre optic cable on embedded in the walls of the pipette tip holder is typically the end of an industry standard SMA fibre optic connector. For most SMA connectors the approximate 1 mm end diameter can be used to effectively measure transmission of radiation across a pipette tip of equal or greater internal diameter.

By applying blank samples, samples missing the component being analysed, the difference in transmitted light intensity can be used to characterize the sample according to

A=−log(l/l·sub·0)

where l.sub.0 is intensity of transmitted light through the blank sample, a sample with the component being analysed absent, and l is the intensity of light transmitted through the sample and A is the absorbance value which can be related to the concentration of the component being analysed by Beer's law.

Thus, when compared with a blank sample, the concentration of the component of interest being analysed can be directly determined from the absorbance A.

Two or more of the photometric devices can be grouped in unitary form to measure multiple samples simultaneously. Such a multiple parallel photometer system can be employed with a multi-pipette robot system such as the MultiPROBE II made by Packard Instrument Company of Meriden, Conn.)

Samples can also be measured with a differential absorbance path by introducing pipette tips of different internal diameters. Measuring the sample in to different tips of differing internal diameter provides absorbance measurements with differing path lengths, where the difference in path length combined with the difference in transmitted intensity can be used to calculate the sample absorbance. This can be of significant value where the sample is strongly absorbing and the difference in path length can be determined more accurately than the absolute path length of the apparatus in the measurement position. Measurements are taken firstly with a relatively long path length and then with a relatively short path length. (P). The absorbance at the shorter path length is then subtracted from the absorbance of one or more of the longer paths to arrive at the absorbance of the sample.

### The Detailed Construction

These embodiments show the use of a pipette tip that has high optical quality and permits the passage of those wavelengths needed to characterize the liquid contained therein;

They make possible the use of a pipette tip, which dispenses and aspirates by the use of a detachable pipette device, which may or may not use a piston internal to the pipette and/or internal and integral to the pipette tip.

They also envisage the use of a pipette tip which may be left attached to pipette tip during sample analysis or reattached to the pipette device following analyses, thereby providing a means to recover the sample for subsequent applications and manipulations.

As shown in FIG. 1, a pipette tip 11 is designed so as to be a close sealing fit on the end of its holder 12. The fit can vary between a push fit and a force fit, depending on the way the pipette is manufactured for its intended application; but preferably for most practical purposes it will be a firm push fit.

As shown in FIG. 2 in cross-section along its axis the pipette tip 11 can be divided visually into an axial succession of sections a through e. But it is constructed as one integral unit and is made, in this instance, not from the conventional polypropylene material (which is unsuitable for use in most spectroscopic measurements including those reliant on detecting UV wavelengths) but from a material which has appropriate properties for moulding into a 10 UL pipette tip and additionally possesses the appropriate spectroscopic properties necessary to enable transmission of radiation within a desired range to 20 nm through 900 nm.

One such suitable material is a cyclic olefin copolymer currently marketed under the name TOPAS 8007×10 by the Ticona Company. The published properties of this material are given in an appendix following this description and its transmissibility for spectrophotometric purposes is illustrated in FIG. 5 graphically.

Section a of the pipette tip 11 provides the lead-in as the pipette tip 11 is fitted onto the receiving end of the holder 12. It is internally tapered as shown. It is also externally tapered and, again as shown, in this particular embodiment it is ribbed.

The ribs are equally circumferentially spaced about the external surface of section a and are referenced 13 in the drawings. In this particular embodiment there are six of them and, again in this particular embodiment, the endmost external section of the length a ends in a diametrically enlarged portion 14.

The next length section b of the pipette tip 11 tapers externally and is tapered, but only to a very slight degree of taper, internally. This is the section which, as FIG. 3 shows, forms progressively a sealing fit on the end of the holder 12. It may be roughened or otherwise internally surface treated to enhance that progressive fit.

Progressing axially along the length of the pipette tip 11 the next section c is of constant wall thickness and is equally tapered internally and externally; the next section d has the same features but it is clear from FIG. 2 that the wall thickness of this next section is appreciably less than the wall thickness of section c.

The last section e of the pipette tip is of constant diameter inside and out. It has the same wall thickness as section d. The average value of this thin wall section d-e is 0.25 mm and the surface finish of the whole tip 13—especially that of section e—is a smooth high gloss optically transparent finish which, together with the relatively minimal thickness of wall of section e, provides optimal radiation transmission in use.

The holder—or pipette barrel—12 will be constructed appropriately and its details can be left to the intended skilled addressee of this specification. But FIG. 4 shows spectrophotometric apparatus, embodying the invention and incorporating the pipette tip 11, in use. The pipette tip is held between two surfaces, one containing a photometric or a spectrophotometric source, and the other a photometric or spectrophotometric detector; and an optical path is established through the walls of the pipette tip and through the sample between the two surfaces. As just mentioned, the pipette tip will be finished to a sufficiently high optical quality to permit the passage of those wavelengths needed to characterise the liquid contained therein.

Modifications within the scope of the skilled reader and his knowledge in the art will become apparent but the reader is specifically redirected to the art of the record, listed previously in this specification by way of a formal information disclosure, for any further background details he may need.

Once successfully put into practice in accordance with the invention, sample path lengths in the range 0.1 up to 2 mm can be used to generate absorbance values that can readily be corrected to the industry standard 1 cm path equivalent.

### APPENDIX

### TOPAS 8007×10|COC|Unfilled|Ticona

### Description

Cyclic OLefin CopoLymer (amorphous, transparent)
Special grade with a HDT/B of 75 deg C. This grade offers exceptionally high light transmission in the ultraviolet spectral range.
UL-registration for a thickness more than 1.5 mm as UL 94 HB.
Ranges of application: all applications where high light transmittance in the UV range is required, e.g. DNA analytic, micro titer plates, cuvettes
Resistant to radiation and ETO sterilization.
Complies with USP Class VI and FDA as well as European BgVV.

| | Value Unit | Test Standard |
|---|---|---|
| Physical properties | | |
| Density | 1020 kg/m³ | ISO 1183 |
| Melt volume rate (MVR) | 32 cm³/10 min | ISO 1133 |
| MVR test temperature | 260° C. | ISO 1133 |
| MVR test load | 2.16 kg | ISO 1133 |
| Water absorption (23° C.-sat) | 0.01% | ISO 62 |
| Mechanical properties | | |
| Tensile modulus (1 mm/min) | 2600 MPa | ISO 527-2/1A |
| Tensile stress at yield (50 mm/min) | 63 MPa | ISO 527-2/1A |
| Tensile strain at yield (50 mm/min) | 4.5% | ISO 527-2/1A |
| Tensile stress at break (50 mm/min) | 32 MPa | ISO 527-2/1A |
| Tensile strain at break (50 mm/min) | >10% | ISO 527-2/1A |
| Charpy impact strength @ 23° C. | 20 kJ/m² | ISO 179/1eU |
| Charpy notched impact strength @ 23° C. | 2.6 kJ/m² | ISO 179/1eA |
| Thermal properties | | |
| Glass transition temperature (10° C./min) | 80° C. | ISO 11357-1,-2,-3 |
| DTUL @ 1.8 MPa | 68° C. | ISO 75-1/-2 |
| DTUL @ 0.45 MPa | 75° C. | SO 75-1/-2 |
| Vicat softening temperature B50 (50° C./h 50 N) | 80° C. | ISO 306 |
| Coeff.of linear therm. expansion (parallel) | 0.7E−4/° C. | ISO 11359-2 |
| Flammability @1.6 mm nom. thickn. | HB class | UL94 |
| thickness tested (1.6) | 1.6 mm | UL94 |
| UL recognition (1.6) | UL- | UL94 |
| Electrical properties | | |
| Relative permittivity —100 Hz | 2.35- | IEC 60250 |
| Volume resistivity | >1E14 Ohm * m | IEC 60093 |
| Comparative tracking index CTI | >600- | IEC 60112 |
| Optical properties | | |
| Deg. of light transmission | 91% | Internal |
| Refractive index | 1.53- | ISO 489 |
| Test specimen production | | |
| Processing conditions acc. ISO | 7792-2- | Internal |
| Injection molding melt temperature | 230° C. | ISO 294 |
| Injection molding mold temperature | 50° C. | ISO 294 |
| Injection molding flow front velocity | 100 mm/s | ISO 294 |
| Injection molding hold pressure | 40 MPa | ISO 294 |
| Rheological Calculation properties | | |
| Density of melt | 898 kg/m³ | Internal |
| Thermal conductivity of melt | 0.19 W/(m K) | Internal |
| Specific heat capacity of melt | 2550 J/(kg K) | Internal |

Additional technical information can currently be obtained by calling the telephone numbers +49 (0) 693 051 6299 for Europe and +1 908 598-45 169 for the Americas.

1.-9. (canceled)

10. A pipette tip which is optically adapted for photometric analysis of a relatively small volume—selected typically from the range 1 to 10 microlitres—of liquid contained therein and with means for adapting said pipette tip to be readily attachable to and detachable from a pipette barrel, in use; said means for adaptation acting to hold the pipette tip and a sample contained therein in an optical path for delivery and measurement of radiation passed across said tip and hence through said sample; and wherein a sample—dispensing end region of said pipette tip through which, in use, the radiation passes, has a uniform wall thickness.

11. A pipette tip according to claim 10 and wherein an external portion of the pipette tip is ribbed in order to assist its attachment to and detachment from the pipette barrel.

12. A pipette tip according to claim 11 and wherein there is more than one rib and some at least of said ribs extend axially along the surface of the ribbed region.

13. A pipette tip according to claim 10 and in which the wall thickness is in the order of 0.25 mm.

14. A pipette tip according to claim 13 and in which the said end region of approximately uniform wall thickness occupies substantially one third to one half of the overall length of the pipette tip.

15. A pipette tip according to claim 14 and in which substantially the last three fifths of the region of uniform wall thickness is of uniform internal diameter.

16. A pipette tip according to claim 14 and in which substantially the last three fifths of the region of uniform wall thickness is of uniform external diameter.

17. A pipette tip according to claim 14 and in which substantially the last three fifths of the region of uniform wall thickness is of uniform internal and external diameter

18. Apparatus comprising a pipette tip according to claim 10 in combination with a pipette adapted to co-operate therewith for use in photometric analysis.

19. Apparatus according to claim 10 and in which the necessary radiation source means and receiving means are formed into one substantially continuous surface surrounding the pipette tip sample containing region in use.

20. Methods, selected from the group comprising photometric, spectrophotometric, fluorometric and spectrofluorometric analysis of analysing liquids using a pipette tip in accordance with claim 10.
